(19) United States
(12) Patent Application Publication
(10) Pub. No.: US 2016/0375809 A1
(43) Pub. Date: Dec. 29, 2016

(54) Bodily Support Assembly

(71) Applicant: Son Nguyen, Colorado Springs, CO (US)

(72) Inventor: Son Nguyen, Colorado Springs, CO (US)

(21) Appl. No.: 14/751,433

(22) Filed: Jun. 26, 2015

(51) Int. Cl. B60N 2/66; B60N 2/48

(52) U.S. Cl. CPC B60N 2/665; B60N 2/4805

(57) ABSTRACT

A bodily support assembly includes a panel that may be positioned on a chair such that the panel extends along each of a seat, a back rest and a head rest of the chair thereby facilitating a user to sit on the panel. A pad is coupled to the panel such that the pad may be sat upon. A plurality of supports is provided and each of the supports is coupled to the panel. A pump is coupled to the panel and the pump selectively inflates each of the supports. A plurality of valves is provided and each of the valves is fluidly attached to an associated one of the supports to selectively deflate the associated support. A first strap, a second strap and a pair of third straps are coupled to the panel. Each of the first, second and third straps may be secured to the chair.

### BACKGROUND OF THE DISCLOSURE

### Field of the Disclosure

The disclosure relates to support devices and more particularly pertains to a new support device for providing lumbar and neck support on a chair.

### SUMMARY OF THE DISCLOSURE

An embodiment of the disclosure meets the needs presented above by generally comprising a panel that may be positioned on a chair such that the panel extends along each of a seat, a back rest and a head rest of the chair thereby facilitating a user to sit on the panel. A pad is coupled to the panel such that the pad may be sat upon. A plurality of supports is provided and each of the supports is coupled to the panel. Thus, each of the supports provides support for the user when the user sits on the panel. A pump is coupled to the panel and the pump is in fluid communication with each of the supports. The pump selectively inflates each of the supports. A plurality of valves is provided and each of the valves is fluidly attached to an associated one of the supports. Each of the valves may be manipulated to selectively deflate the associated support. A first strap is coupled to the panel. The first strap may be secured around the backrest of the chair such that the panel is removably coupled to the chair. A second strap is coupled to the panel. The second strap may be secured around the headrest of the chair such that the panel is removably coupled to the chair. A pair of third straps is each is coupled to the panel. Each of the third straps may be secured around the headrest of the chair such that the panel is removably coupled to the chair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a bodily support assembly according to an embodiment of the disclosure.

FIG. 2 is a right side view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

FIG. 6 is a perspective view of a pump of an embodiment of the disclosure

### DESCRIPTION OF THE PREFERRED EMBODIMENT

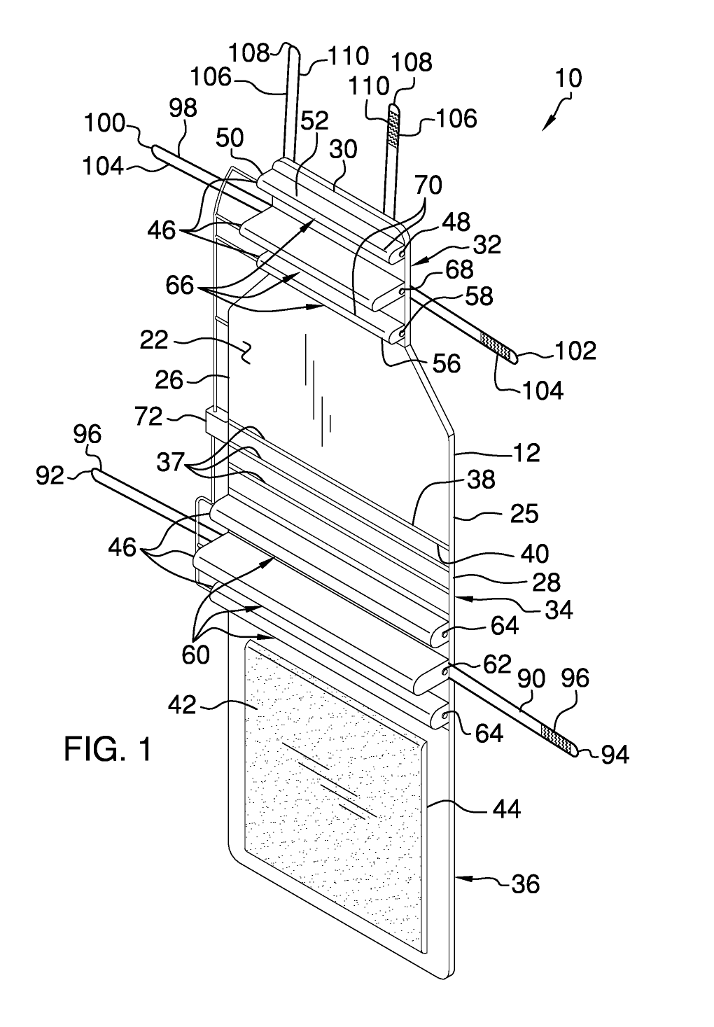

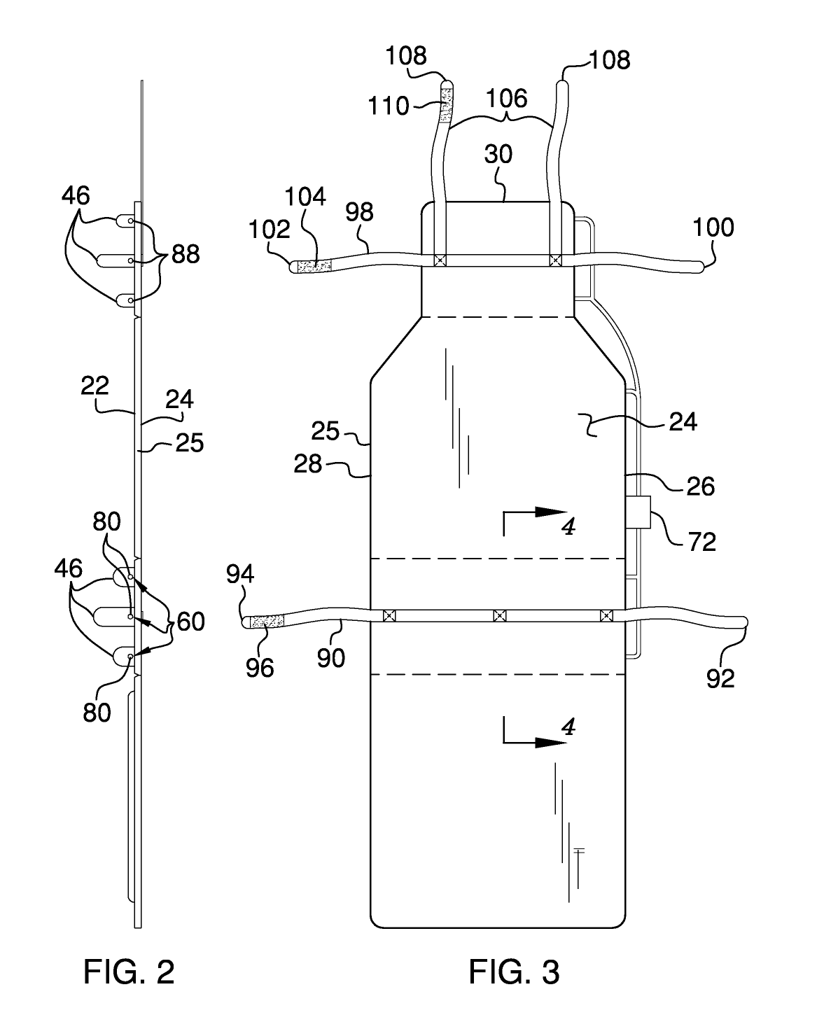

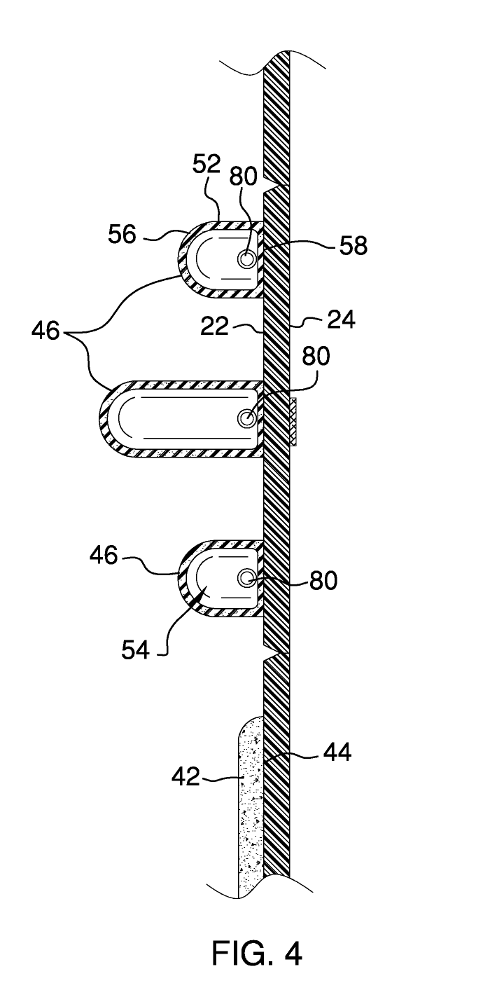

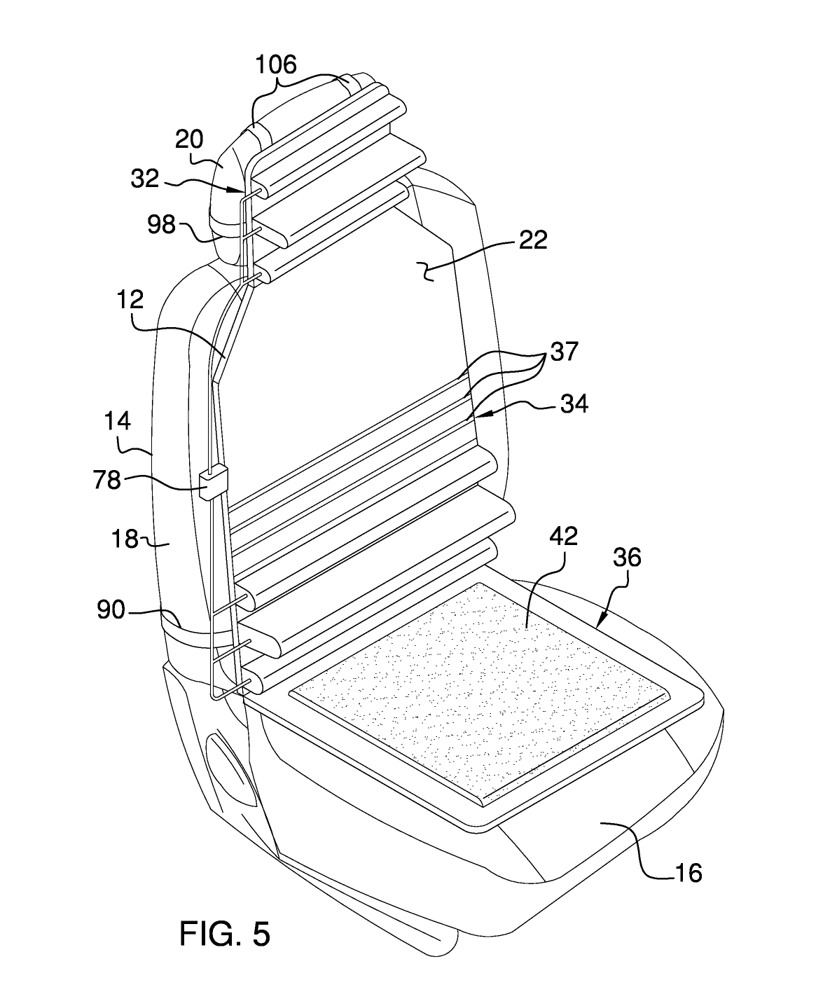

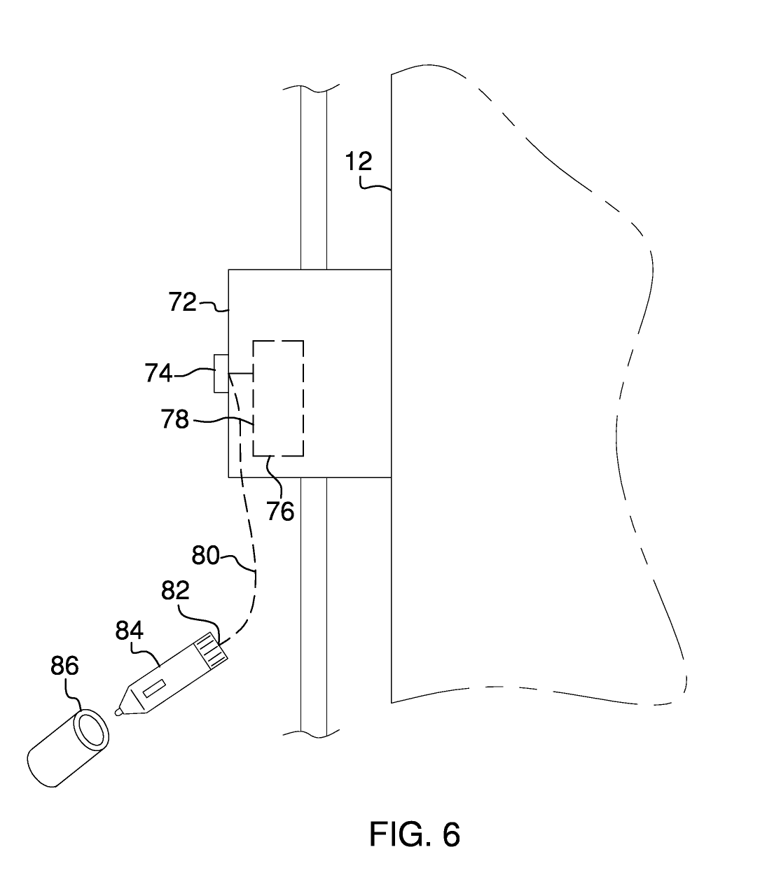

With reference now to the drawings, and in particular to FIGS. 1 through 6 thereof, a new support device embodying the principles and concepts of an embodiment of the disclosure and generally designated by the reference numeral 10 will be described.

As best illustrated in FIGS. 1 through 6, the bodily support assembly 10 generally comprises a panel 12 that may be positioned on a chair 14 such that the panel 12 extends along each of a seat 16, a back rest 18 and a head rest 20 of the chair 14 thereby facilitating a user to sit on the panel 12. The chair 14 may be a vehicle seat or the like. The panel 12 has a front surface 22, a back surface 24 and a peripheral edge 25 extending between the front surface 22 and the back surface 24. The peripheral edge 25 has a first lateral side 26, a second lateral side 28 and a top side 30. Additionally, the panel 12 has an upper section 32, a medial section 34 and a lower section 36. Each of the first lateral side 26 and the second lateral side 28 angles inwardly between the medial section 34 and the upper section 32. Thus, the upper section 32 has a width that is less than each of the medial section 34 and the lower section 36.

The panel 12 is foldable between the medial section 34 and the lower section 36 such that the back surface 24 corresponding to the lower section 36 may abut the seat 16 of the chair 14. The back surface 24 corresponding to the medial section 34 may abut the back rest 18 of the chair 14 and the back surface 24 corresponding to the upper section 32 may abut the head rest 20 of the chair 14. The medial section 34 has a plurality of pleats 37 that each extends between the first lateral side 26 and the second lateral side 28. The pleats 37 are spaced apart from each other and each of the pleats 37 has an upper bounding surface 38 and a lower bounding surface 40.

The upper bounding surface 38 and the lower bounding surface 40 of an associated one of the pleats 37 are selectively matable. Thus, the medial section 34 is adjustable between a minimum length and a maximum length thereby facilitating the panel 12 to accommodate a variety of heights of users. Each of the lower bounding surface 40 and the upper bounding surface 38 of each of the pleats 37 may comprise complementary hook and loop fasteners or the like.

A pad 42 is coupled to the panel 12 such that the pad 42 may be sat upon. The pad 42 has a lower surface 44. The lower surface 44 is attached to the front surface 22 corresponding to the lower section 36. The pad 42 substantially covers the lower section 36.

A plurality of supports 46 is provided and each of the supports 46 is coupled to the panel 12. Thus, each of the supports 46 may provide support for the user when the user sits on the panel 12. Each of the supports 46 has a first end 48, a second end 50 and an outer wall 52 extending between the first end 48 and the second end 50. Each of the supports 46 is substantially hollow to define an air space 54 within each of the supports 46. The outer wall 52 has a front side 56 and a back side 58 and the back side 58 of each of the supports 46 is coupled to the front surface 22 of the panel 12. Each of the supports 46 extends between the first lateral side 26 and the second lateral side 28 and the front side 56 of each of the supports 46 is curved.

The plurality of supports 46 includes a first set of cushions 60 and each of the first set of cushions 60 is positioned on the front surface 22 corresponding to the medial section 34. Each of the first set of cushions 60 extends between the first lateral side 26 and the second lateral side 28 of the panel 12. The first set of cushions 60 is spaced apart from each other and each of the first set of cushions 60 is positioned adjacent to an intersection of the medial section 34 and the lower section 36. Thus, each of the first set of cushions 60 may provide lumbar support for the user when the user sits on the panel 12. The first set of cushions 60 includes a central cushion 62 and a pair of end cushions 64. The central cushion 62 extends away from the panel 12 a distance that is greater than a distance each of the end cushions 64 extends from the panel 12.

The plurality of supports 46 additionally includes a second set of cushions 66 and each of the second set of cushions 66 is positioned on the front surface 22 corresponding to the upper section 32. Each of the second set of cushions 66 extends between the first lateral side 26 and the second lateral side 28 of the panel 12. The second set of cushions 66 is spaced apart from each other and each of the second set of cushions 66 is positioned adjacent to an intersection of the medial section 34 and the upper section 32. Thus, each of the second set of cushions 66 provides neck support for the user when the user sits on the panel 12. The second set of cushions 66 includes a middle cushion 68 and a pair of surrounding cushions 70. The middle cushion 68 extends away from the panel 12 a distance that is greater than a distance each of the surrounding cushions 70 extends from the panel 12.

A pump 72 is coupled to the panel 12. The pump 72 is in fluid communication with the air space 54 of each of the supports 46 such that the pump 72 may selectively inflate the air space 54 of each of the supports 46. The pump 72 may be fluidly coupled to each of the supports 46 through the use of air lines or other conventional means of transferring air. The pump 72 may be an air pump or the like. A switch 74 is electrically coupled to the pump 72. The switch 74 may be manipulated to turn the pump 72 on and off.

A power supply 76 is coupled to the pump 72 and the power supply 76 is electrically coupled to the switch 74. The power supply 76 may comprise at least one battery 78. Alternatively, the power supply 76 may comprise a cord 80 extending away from the pump 72. The cord 80 may have a distal end 82 with respect to the pump 72 and a plug 84 may be electrically coupled to the distal end 82. The plug 84 may be electrically coupled to a power source 86 and the power source 86 may be a cigarette lighter in the vehicle.

A plurality of valves 88 is provided and each of the valves 88 is fluidly attached to an associated one of the supports 46. Each of the valves 88 is positioned on the first end 48 of an associated one of the support 46. Each of the valves 88 is in fluid communication with the air space 54 of the associated support 46 such that each of the valves 88 may be manipulated to selectively deflate the associated support 46.

A first strap 90 is coupled to the panel 12 such that the first strap 90 may be secured around the backrest 18 of the chair 14 such that the panel 12 is removably coupled to the chair 14. The first strap 90 has a first end 92 and a second end 94. The first strap 90 is positioned on the back surface 24 corresponding to the medial section 34. The first end 92 of the first strap 90 and the second end 94 of the first strap 90 extend beyond an associated one of the first lateral side 26 and the second lateral side 28 of the panel 12.

A pair of first couplers 96 is provided and each of the first couplers 96 is attached to the first strap 90. Each of the first couplers 96 is positioned adjacent to an associated one of the first end 92 of the first strap 90 and the second end 94 of the first strap 90. Each of the first couplers 96 is complementary such that the first end 92 of the first strap 90 is matable to the second end 94 of the first strap 90. Each of the first couplers 96 may comprise a hook and loop fastener or the like.

A second strap 98 is coupled to the panel 12 such that the second strap 98 may be secured around the headrest 20 of the chair 14 such that the panel 14 is removably coupled to the chair 14. The second strap 98 has a first end 100 and a second end 102. The second strap 98 is positioned on the back surface 24 corresponding to the upper section 32. The first end 100 of the second strap 98 and the second end 102 of the second strap 98 extend beyond an associated one of the first lateral side 26 and the second lateral side 28 of the panel 12.

A pair of second couplers 104 is provided and each of the second couplers 104 is attached to the second strap 98. Each of the second couplers 104 is positioned adjacent to an associated one of the first end 100 of the second strap 98 and the second end 102 of the second strap 98. Each of the second couplers 104 is complementary such that the first end 100 of the second strap 98 is matable to the second end 102 of the second strap 98. Each of the second couplers 104 may comprise a hook and loop fastener or the like.

A pair of third straps 106 is provided and each of the third straps 106 is coupled to the panel 12. Each of the third straps 106 may be secured around the headrest 20 of the chair 14 such that the panel 12 is removably coupled to the chair 14. Each of the third straps 106 is positioned on the back surface 24 corresponding to the upper section 32 and each of the third straps 106 may intersect with the second strap 98. Each of the third straps 106 is spaced apart from each other and each of the third straps 106 extends beyond the top side 30 of the panel 12. Each of the third straps 106 has a distal end 108 with respect to the top side 30.

A pair of third couplers 110 is provided and each of the third couplers 110 is attached to an associated one of the third straps 106. Each of the third couplers 110 is positioned adjacent to the distal end 108 of the associated third strap 106. Each of the third couplers 110 may comprise a hook and loop fastener or the like such that the distal end 108 of each of the third straps 106 is matable with the second strap 98.

In use, the panel 12 is positioned on the chair 14 and each of the first strap 90, the second strap 98 and the third straps 106 are secured to the chair 14. The switch 74 on the pump 72 is manipulated to inflate each of the supports 46 to a desired firmness and the panel 12 is sat upon. The valves 88 are manipulated to release air from each of the supports 46 in order to reduce the firmness of the supports 46 or to completely deflate each of the supports 46. The panel 12 enhances a comfort of the chair 14 and the panel 12 serves to reduce stiffness and physical discomfort for the user. The panel 12 is used in public transportation, personal transportation or at home.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bodily support assembly configured to provide lumbar and neck support on a chair, said assembly comprising:
a panel being configured to be positioned on a chair such that said panel extends along each of a seat, a back rest and a head rest of the chair thereby facilitating a user to sit on said panel, said panel has a front surface, a first lateral side, a second lateral side a medial section and a lower section;
a pad being coupled to said panel wherein said pad is configured to be sat upon;
a plurality of supports, each of said supports being coupled to said panel wherein each of said supports is configured to provide support for the user when the user sits on said panel, said plurality of supports comprising
a first set of cushions, each of said first set of cushions being positioned on said front surface corresponding to said medial section, each of said first set of cushions extending between said first lateral side and said second lateral side of said panel, said first set of cushions being spaced apart from each other, each of said first set of cushions being positioned adjacent to an intersection of said medial section and said lower section wherein each of said first set of cushions is configured to provide lumbar support for the user when the user sits on said panel, and
said first set of cushions including a central cushion and a pair of end cushions, said central cushion extending away from said panel a distance being greater than each of said end cushions extends from said panel;
a pump being coupled to said panel, said pump being in fluid communication with each of said supports wherein said pump is configured to selectively inflate each of said supports;
a plurality of valves, each of said valves being fluidly attached to an associated one of said supports wherein each of said valves is configured to be manipulated to selectively deflate said associated support;
a first strap being coupled to said panel wherein said first strap is configured to be secured around the backrest of the chair such that said panel is removably coupled to the chair;
a second strap being coupled to said panel wherein said second strap is configured to be secured around the headrest of the chair such that said panel is removably coupled to the chair; and
a pair of headrest straps, each of said pair of headrest straps being coupled to said panel wherein each of said pair of headrest straps is configured to be secured around the headrest of the chair such that said panel is removably coupled to the chair.

2. The assembly according to claim 1, wherein said panel has a front surface, a back surface and a peripheral edge extending between said front surface and said back surface, said peripheral edge having a first lateral side, a second lateral side and a top side, said panel having an upper section, a medial section and a lower section.

3. The assembly according to claim 2, wherein each of said first lateral side and said second lateral side angles inwardly between said medial section and said upper section such that said upper section has a width being less than each of said medial section and said lower section, said panel being foldable between said medial section and said lower section such that said back surface corresponding to said lower section is configured to abut a seat of the chair, said back surface corresponding to said medial section being configured to abut a back rest of the chair and said back surface corresponding to said upper section being configured to abut a head rest of the chair.

4. The assembly according to claim 2, wherein said medial section has a plurality of pleats extending between said first lateral side and said second lateral side, said pleats being spaced apart from each other, each of said pleats having an upper bounding surface and a lower bounding surface.

5. The assembly according to claim 4, wherein said upper bounding surface and said lower bounding surface of an associated one of said pleats is selectively matable such that said medial section is adjustable between a minimum length and a maximum length wherein said panel is configured to accommodate a variety of heights of users.

6. The assembly according to claim 2, wherein said pad has a lower surface, said lower surface being attached to said front surface corresponding to said lower section, said pad substantially covering said lower section.

7. The assembly according to claim 1, wherein each of said supports has a first end, a second end and an outer wall extending between said first end and said second end, each of said supports being substantially hollow to define an air space within each of said supports.

8. The assembly according to claim 7, wherein:
said panel has a front surface, a first lateral side and a second lateral side; and
said outer wall has a front side and a back side, said back side of each of said supports being coupled to said front surface of said panel, each of said supports extending between said first lateral side and said second lateral side, said front side of each of said supports being curved.

9. (canceled)

10. The assembly according to claim 1, wherein
said plurality of supports further comprises:
a second set of cushions, each of said second set of cushions being positioned on said front surface corresponding to said upper section, each of said second set of cushions extending between said first lateral side and said second lateral side of said panel, said second set of cushions being spaced apart from each other, each of said second set of cushions being positioned adjacent to an intersection of said medial section and said upper section wherein each of said second set of cushions is configured to provide neck support for the user when the user sits on said panel, and
said second set of cushions including a middle cushion and a pair of surrounding cushions, said middle cushion extending away from said panel a distance being greater than each of said surrounding cushions extends from said panel.

11. The assembly according to claim 1, wherein:
each of said cushions has a first end and an air space; and
each of said valves is positioned on said first end of an associated one of said supports, each of said valves being in fluid communication with said air space of said associated support.

12. The assembly according to claim 1, wherein:
said panel has a back surface, a first lateral side, a second lateral side and a medial section; and
said first strap has a first end and a second end, said first strap being positioned on said back surface corresponding to said medial section such that said first end and said second end extends beyond an associated one of said first lateral side and said second lateral side of said panel, said first end being matable to said second end.

13. The assembly according to claim 1, wherein:
said panel has a back surface, a first lateral side, a second lateral side and an upper section; and
said second strap has a first end and a second end, said second strap being positioned on said back surface corresponding to said upper section such that said first end of said second strap and said second end of said second strap extends beyond an associated one of said first lateral side and said second lateral side of said panel, said first end of said second strap being matable to said second end of said second strap.

14. The assembly according to claim 1, wherein:
said panel has a back surface, a top side and an upper section; and
each of said pair of headrest straps is positioned on said back surface corresponding to said upper section, each of said pair of headrest straps intersecting with a second strap, each of said pair of headrest straps being spaced apart from each other, each of said pair of headrest straps extending beyond said top side of said panel, each of said pair of headrest straps having a distal end with respect to said top side, said distal end of each of said pair of headrest straps being matable with said second strap.

15. The assembly according to claim 1, further comprising a power supply being electrically coupled to said pump, said power supply comprising at least one battery.

16. A bodily support assembly configured to provide lumbar and neck support on a chair, said assembly comprising:
a panel being configured to be positioned on a chair such that said panel extends along each of a seat, a back rest and a head rest of the chair thereby facilitating a user to sit on said panel, said panel having a front surface, a back surface and a peripheral edge extending between said front surface and said back surface, said peripheral edge having a first lateral side, a second lateral side and a top side, said panel having an upper section, a medial section and a lower section, each of said first lateral side and said second lateral side angling inwardly between said medial section and said upper section such that said upper section has a width being less than each of said medial section and said lower section, said panel being foldable between said medial section and said lower section such that said back surface corresponding to said lower section is configured to abut the seat of the chair, said back surface corresponding to said medial section being configured to abut the back rest of the chair and said back surface corresponding to said upper section being configured to abut the head rest of the chair, said medial section having a plurality of pleats extending between said first lateral side and said second lateral side, said pleats being spaced apart from each other, each of said pleats having an upper bounding surface and a lower bounding surface, said upper bounding surface and said lower bounding surface of an associated one of said pleats being selectively matable such that said medial section is adjustable between a minimum length and a maximum length wherein said panel is configured to accommodate a variety of heights of users;
a pad being coupled to said panel wherein said pad is configured to be sat upon, said pad having a lower surface, said lower surface being attached to said front surface corresponding to said lower section, said pad substantially covering said lower section;
a plurality of supports, each of said supports being coupled to said panel wherein each of said supports is configured to provide support for the user when the user sits on said panel, each of said supports having a first end, a second end and an outer wall extending between said first end and said second end, each of said supports being substantially hollow to define an air space within each of said supports, said outer wall having a front side and a back side, said back side of each of said supports being coupled to said front surface of said panel, each of said supports extending between said first lateral side and said second lateral side, said front side of each of said supports being curved, said plurality of supports comprising:
a first set of cushions, each of said first set of cushions being positioned on said front surface corresponding to said medial section, each of said first set of cushions extending between said first lateral side and said second lateral side of said panel, said first set of cushions being spaced apart from each other, each of said first set of cushions being positioned adjacent to an intersection of said medial section and said lower section wherein each of said first set of cushions is configured to provide lumbar support for the user when the user sits on said panel, said first set of cushions including a central cushion and a pair of end cushions, said central cushion extending away from said panel a distance being greater than each of said end cushions extends from said panel, and
a second set of cushions, each of said second set of cushions being positioned on said front surface corresponding to said upper section, each of said second set of cushions extending between said first lateral side and said second lateral side of said panel, said second set of cushions being spaced apart from each other, each of said second set of cushions being positioned adjacent to an intersection of said medial section and said upper section wherein each of said second set of cushions is configured to provide neck support for the user when the user sits on said panel, said second set of cushions including a middle cushion and a pair of surrounding cushions, said middle cushion extending away from said panel a distance being greater than each of said surrounding cushions extends from said panel;
a pump being coupled to said panel, said pump being in fluid communication with said air space of each of said supports wherein said pump is configured to selectively inflate said air space of each of said supports;
a plurality of valves, each of said valves being fluidly attached to an associated one of said supports, each of said valves being positioned on said first end of an associated one of said support, each of said valves being in fluid communication with said air space of said associated support wherein each of said valves is configured to be manipulated to selectively deflate said associated support;
a first strap being coupled to said panel wherein said first strap is configured to be secured around the backrest of the chair such that said panel is removably coupled to the chair, said first strap having a first end and a second end, said first strap being positioned on said back surface corresponding to said medial section such that said first end and said second end extends beyond an associated one of said first lateral side and said second lateral side of said panel, said first end being matable to said second end;
a second strap being coupled to said panel wherein said second strap is configured to be secured around the headrest of the chair such that said panel is removably coupled to the chair, said second strap having a first end and a second end, said second strap being positioned on said back surface corresponding to said upper section such that said first end of said second strap and said second end of said second strap extends beyond an associated one of said first lateral side and said second lateral side of said panel, said first end of said second strap being matable to said second end of said second strap;
a pair of headrest straps, each of said pair of headrest straps being coupled to said panel wherein each of said pair of headrest straps is configured to be secured around the headrest of the chair such that said panel is removably coupled to the chair, each of said pair of headrest straps being positioned on said back surface corresponding to said upper section, each of said pair of headrest straps intersecting with said second strap, each of said pair of headrest straps being spaced apart from each other, each of said pair of headrest straps extending beyond said top side of said panel, each of said pair of headrest straps having a distal end with respect to said top side, said distal end of each of said pair of headrest straps being matable with said second strap; and
a power supply being electrically coupled to said pump, said power supply comprising at least one battery.
